(19) United States
(12) Patent Application Publication
(10) Pub. No.: US 2005/0102206 A1
(43) Pub. Date: May 12, 2005

(54) Systems and methods for contingent obligation retainable deduction securities

(76) Inventors: Serkan Savasoglu, New York, NY (US); Kevin G. Woodruff, New York, NY (US); Nathan McMurtray, New York, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/703,973

(22) Filed: Nov. 7, 2003

(51) Int. Cl. G06F 17/60

(52) U.S. Cl. 705/35

(57) ABSTRACT

A convertible security may include a maturity component, a conversion component, and a contingent component. In general, the maturity component provides a maturity term of no more than five years. The conversion component provides terms and conditions for converting the convertible security for another asset. The contingent component provides one or more contingent payments upon the occurrence of one or more specified conditions. The contingent component is structured to ensure that the convertible security qualifies for treatment as a contingent payment debt instrument under the tax code, wherein the comparable yield of the convertible security is greater than applicable Federal rate (AFR) plus five percentage points.

### TECHNICAL FIELD

The present invention relates generally to investment instruments and, more particularly, to systems and methods for enhancing investment securities to obtain desirable tax treatment.

### BACKGROUND

Firms traditionally have issued conventional securities such as straight debt and common stock in order to raise capital. In general, straight debt securities (e.g., bonds, notes, loans, mortgages) raise capital by borrowing and promising to repay a principal amount and interest on a specified future date. Common stock securities, on the other hand, raise capital by selling an equity interest in the firm. Owners of common stock typically receive voting rights regarding firm matters and may benefit through appreciation of the stock value and/or receiving dividends.

In addition to conventional types of securities, firms also have a variety of more sophisticated hybrid investment instruments at their disposal. These hybrid securities often may have attributes of several different types of securities (e.g., debt components and equity components) and may change optionally or automatically at certain points in time or depending on market conditions. Convertible securities, such as convertible debt, for instance, provide the issuer and/or the holder with the option of exchanging the convertible securities for other related securities, such as common stock. Convertible securities may be attractive to investors due to the mix of features, for example, earning interest like bonds when the stock price is down or flat and increasing in value like common stock when the stock price rises.

In some cases, a convertible security may include a contingent interest feature, which is triggered upon the occurrence of a specified condition. For example, the convertible security may provide contingent interest payments if the trading price of the security for each of the five trading days ending on the trading day prior to the first day of such six-month period is greater than or equal to 150% of the par amount for cash-pay bonds or 150% of the accreted value for zero-coupon or discount bonds. The first period for which contingent interest may be paid may be the six-month period starting at the first date the bonds become callable by the issuer. The contingent interest amount may be a fixed percentage of the average market price of the bonds on the five trading days prior to the first day of such six-month period.

For tax purposes, if the terms of a convertible security provide for contingent interest payments that are neither remote nor incidental, the issuer may take tax deductions based on the yield it would pay on a fixed-rate nonconvertible debt instrument with terms and conditions similar to those of the convertible security (“comparable yield”). The deductions are based on a schedule of projected payments with respect to the convertible security (“projected payment schedule”). The projected payment schedule should produce a yield equal to the comparable yield. The projected payment schedule is determined at the time of issue. For accounting purposes, the issuer of the convertible security may need to establish deferred tax liability and deferred tax expense entries.

In every annual tax reporting period, the issuer deducts a value equal to the tax adjusted issue price as of the beginning of the period multiplied by the comparable yield. The “tax adjusted issue price” as of the end of an annual period is the tax adjusted issue price as of the beginning of the period (or the issue price if the period is the first period), plus the tax adjusted issue price as of the beginning of the period multiplied by the comparable yield, minus any non-contingent and projected contingent cash payments to be made during the period. In addition, in applicable periods, deductions are adjusted upward or downward if the actual contingent interest paid is greater or less than that projected under the projected payment schedule. The tax adjusted issue price when the convertible ceases to be outstanding is compared to the value of securities and/or cash delivered to the holders to determine if the tax deductions are permanent. The foregoing tax treatment is in accordance with contingent payment debt instrument (CPDD) regulations.

By including a contingent interest feature, a convertible security can qualify for tax treatment as a (CPDI). As a result, as discussed above, issuers can claim tax deductions in excess of the stated yield on the convertible security. These excess deductions may be recaptured as income if the issuer does not ultimately deliver to the holders securities with a value equal to or greater than the tax adjusted issue price at the time the convertible security ceases to be outstanding.

However, tax deductions may be limited in certain situations. For example, when a security (e.g., convertible debt) has a term of more than five years with a yield greater than or equal to the applicable Federal rate (AFR), as defined in the Internal Revenue Code Section 1274(d), plus five percentage points, the security may be classified as a high yield discount obligation (HYDO). In such cases, interest is not deductible by the issuer until paid even though the holder is taxed currently. Moreover, if the yield exceeds the AFR plus six percentage points, deductions over the AFR plus six percentage points are disallowed.

It may be advantageous for issuers to qualify for CPDI treatment and avoid HYDO treatment. Therefore, systems and methods for enhancing investment securities to enable the desired treatment are needed.

### SUMMARY

In one general aspect a convertible security includes a maturity component, a conversion component, and a contingent component. In general, the maturity component provides a maturity term of no more than five years. The conversion component provides terms and conditions for exchanging the convertible security for another asset. The contingent component provides one or more contingent payments upon the occurrence of one or more specified conditions. The contingent component is structured and arranged to ensure that the convertible security qualifies for treatment as a contingent payment debt instrument under the tax code.

In other general aspects, a method may include issuing a convertible security to a holder, and a computer system may include an issuing agent (e.g. underwriter) for issuing a convertible security to a holder.

Aspects of the present invention may be implemented by a computer program stored on a computer readable medium. The computer readable medium may comprise a disk, a device, and/or a propagated signal. Other features and advantages will be apparent from the following description, including the drawings, and from the claims.

### DESCRIPTION OF THE FIGURES

FIG. 1 is a diagram illustrating an instrument according to one embodiment of the present invention.

FIG. 2 is a flowchart illustrating a method according to one embodiment of the present invention.

FIG. 3 is a diagram illustrating a system according to one embodiment of the present invention.

### DETAILED DESCRIPTION

The present invention is directed to structures, methods, and systems for investment securities. For simplicity, the basic components of such structures, methods, and systems are provided. However, as would be understood by one of ordinary skill in the art, the structures, systems and methods described below may include various other components, elements, and/or processes in actual implementation.

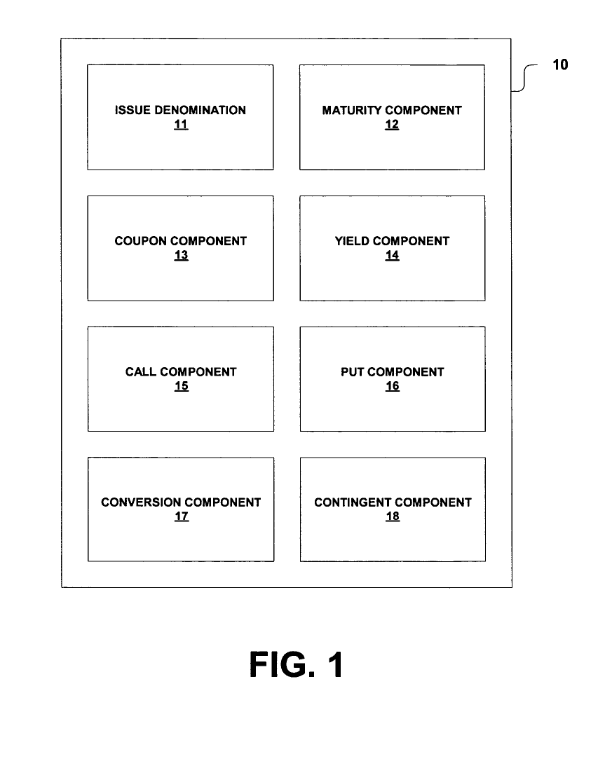

FIG. 1 illustrates one embodiment of a convertible security 10 according to aspects of the present invention. The convertible security 10 may be embodied as one or more paper and/or electronic documents and generally may contain one or more legal rights and obligations in the context of a financial transaction. In many cases, the convertible security 10 may form part of an offering by a company. The convertible security may also be listed on a national securities exchange.

One example of a convertible security 10 is convertible debt (e.g., a convertible bond) that can be exchanged for stock (e.g., common stock) of the issuing company. The convertible debt may be a zero-coupon bond (e.g. bond that pays no coupon), a discount bond (e.g. bond that pays a coupon and is issued at a discount to face value), or a cash-pay convertible bond (e.g. bond that pays a coupon and is issued at face value). The coupon may be a fixed rate or a floating rate (e.g., London Interbank Offered Rate (LIBOR) minus 25 basis points). The convertible debt may be cash-pay for a certain period (e.g., the first five years) and then become a zero-coupon bond for the remainder of the term until maturity.

In one implementation, the convertible security 10 includes an issue denomination 11 (e.g., issue price or initial principal amount) and a maturity component 12. In general, the maturity component 12 indicates the term or life of the convertible security 10. The maturity component typically may express the term as a number of years from the issue date. In some cases, the maturity component 12 provides the date at which debt becomes due for payment.

As shown, the convertible security 10 also may include a coupon component 13 and/or a yield component 14. In general, the coupon component 13 may specify, at the time of issue, that interest payments are to be made at a particular rate and at a particular frequency (e.g., quarterly). If present, the coupon component 14 may express the particular interest rate as a function of the LIBOR or some other variable rate or a fixed rate. In some cases, the interest rate is a percentage of the par value. In some embodiments the interest rate may be zero percent (e.g., a zero-coupon bond).

In general, the yield component 14 may specify, at the time of issue, an annual rate of return based on the coupon rate, the maturity date, put and call dates and prices, and the issue price of the convertible security 10. If present, the yield component 14 is typically expressed as a percentage. The yield component 14 may be expressed as a function of the LIBOR, or some other variable rate or a fixed rate. In some embodiments the yield may be zero percent (e.g., a zero-coupon bond not issued at a discount).

The convertible security 10 may include a call component 15. In one embodiment, the call component 15 specifies, at the time of issue, certain conditions under which the issuer may call the convertible security 10 prior to maturity. In general, calling the convertible security 10 involves redeeming the convertible security 10 for a price. A company may call a bond, for example, when the interest rate it could achieve for a new issue of debt falls below the yield being paid on the bond or when the price of the bond rises to a certain point. The call component 15 may specify an initial time period in which the convertible security 10 cannot be called. For example, the call component 15 may specify, at the time of issue, that the convertible security 10 cannot be called for an initial five-year period.

The convertible security 10 also may include a put component 16. In one embodiment, the put component 16 specifies, at the time of issue, the terms and conditions (e.g., price, dates) under which the holder has the right to sell the security back to the issuer. In general, putting the convertible security 10 may involve the holder providing a put notice to the issuer and redeeming the bond for the par amount or the accreted value of the bond. The “accreted value” of the bond as of the end of an annual period is the accreted value as of the beginning of the period (or the issue price if the period is the first period), plus the accreted value as of the beginning of the period multiplied by the total yield, minus any non-contingent cash payments made during the period. A holder may put a bond, for example, when the stock price underlying the bond is low, interest rates are high, and the issuer's credit spread is high. The put component 16 may specify points in time at which the convertible security 10 can be put.

As shown, the convertible security 10 includes a conversion component 17. In one embodiment, the conversion component 17 specifies, at the time of issue, the terms and conditions for exchanging the convertible security 10 for another asset, such as common stock of the issuer. The conversion component 17 may include, for example, a number of shares of the issuer's common stock (e.g., 5 shares) into which the convertible security 10 can be converted. The conversion component 17 may also include, for example, a conversion price that specifies the dollar amount (e.g., $200) at which the convertible security 10 can be converted into common stock of the issuer.

The conversion component 17 also may include a conversion premium (e.g., 130%) expressing the extent to which the conversion price exceeds the price of the stock at the time of issue. In some situations, a company may set the conversion premium sufficiently low such that investors are willing to pay par value for a convertible security 10 that has no coupon and no yield.

The convertible security 10 includes a contingent component 18. In one embodiment, the contingent component 18 specifies, at the time of issue, one or more payment contingencies that are neither remote nor incidental as required by the tax code. As a result, the convertible security 10 qualifies for CPDI treatment under the tax code.

In one implementation, the contingent component 18 specifies that contingent payments will be made to the holder based on an evaluation over a testing period that determines whether the contingency is triggered. In this implementation, the contingent payments may be specified as a percentage of the average market price of the convertible security 10 during a measurement period (that may differ from the testing period).

In one embodiment, the contingent component 18 may provide that a contingent payment (e.g., contingent interest) will be paid to the holder if the average market price of the convertible security during a testing period (e.g., 5-day period before the end of year 5 of the security), referred hereinafter as the testing period average market price or “TAMP,” is greater than a first threshold amount (e.g., $1400). The first threshold amount may be set at the time of issuance so that there is more than a remote probability (e.g., 10%) that the TAMP will exceed this first threshold amount during the testing period.

The contingent component 18 also may provide that if the TAMP is greater than the first threshold amount but the average market price during a measurement period (e.g., 20 days in total, 5 days ending at each of the first, second, third and fourth anniversary of the security), referred hereinafter as the measurement period average market price, or “MAMP,” is less than a second threshold amount (e.g., $1800), then contingent interest is paid as a certain percentage Y (e.g., 3%) of the MAMP. In one implementation, the percentage Y is calculated so that the contingent interest payable is not insignificant. The second threshold amount may be set at the time of issuance so that the theoretical probability of the MAMP being above this second threshold amount is at least 10%, and Y may be set so that the contingent interest amount defined as Y percent multiplied by the second threshold amount is not insignificant. If Y percent multiplied by the second threshold amount is not insignificant, then Y percent multiplied by the MAMPs above the second threshold amount will also not be insignificant. To measure whether an amount is insignificant or not, the amount may for example be measured against an amount that changes the internal rate of return (IRR) of the projected payment schedule (PPS) cash flows by at least 5% of the IRR. The PPS includes the non-contingent payments and the forward and/or expected values for the contingent payments.

The contingent component 18 also may provide that if the TAMP is greater than the first threshold amount (e.g., $1400) and the MAMP is greater than the second threshold amount (e.g. $1800), then contingent interest is payable as a certain percentage of the second threshold plus an additional percentage (e.g., 0.25%) of the difference between the MAMP and the second threshold amount (e.g., MAMP-$1800). This additional percentage payment when MAMP is above the second threshold amount may provide for an infinite number of possible contingent interest payments. For example, there is no limit for how high the contingent interest payment could be. The infinite number of possible contingent interest payments may be desirable because a finite number of possible contingent interest payments may result in the security to be outside of CPDI rules if one payment schedule is significantly more likely than not to occur.

In another embodiment, the contingent component 18 may be structured in other ways and still allow the convertible security 10 to qualify for treatment under the CPDI regulations. For example, the testing and measurement periods described above may be based on different periods from the ones described above. The contingent interest payment amount may be based on the stock price, a fixed value, or some other benchmark (e.g., interest rate on U.S. Treasury securities or the LIBOR). The determination of whether or not the contingent interest payment will be made may be based on the stock price, or some other benchmark (e.g., interest rate on U.S. Treasury securities or the LIBOR).

In one example of one embodiment, a convertible security 10 may include an issue denomination 11 providing an issue price of $1000, a maturity component 12 providing a term of five years, a coupon component 13 providing a rate of 5%, a yield component 14 providing a 5% yield, a call component 15 providing no call rights by the issuer, a put component 16 providing no puts by holders, and a conversion component 17 providing a conversion premium of 50% based on an initial stock price of $100.

In this example, the convertible security 10 may include a contingent component 18 providing that contingent interest is paid if the TAMP is greater than $1400. If the MAMP is less than $1800, then contingent interest is paid in the amount of 3% of the MAMP. If the MAMP is greater than $1800, then contingent interest is paid in the amount of 3%*$1800+0.25%*(MAMP-$1800).

As described above, the contingent component 18 is structured and arranged to ensure that the convertible security 10 qualifies for CPDI treatment. Namely, the contingent component 18 provides payments that are neither remote nor incidental as required by the tax code. In this example, we assume the comparable yield (e.g., 10%) exceeds the AFR by more than 500 basis points. In addition, because the convertible security 10 matures in five years or less, HYDO treatment does not apply.

In general, the “noncontingent bond method” may be applied to securities that qualify for CPDI treatment. In one implementation, application of the noncontingent bond method involves determining the comparable yield for the convertible security by reference to a fixed-rate nonconvertible debt instrument with terms and conditions similar to those of the convertible security. In addition, a projected payment schedule is determined by treating the stock received upon a conversion of the convertible security 10 as a contingent payment. The comparable yield and the projected payment schedule are used to determine the tax deduction amount for each accrual period.

The comparable yield for the convertible security 10 can be the yield at which a fixed-rate nonconvertible debt instrument with terms and conditions similar to those of the convertible security 10 would be issued. Such terms and conditions may relate to maturity, payment frequency, subordination level, and market conditions, for example. In all cases, the comparable yield must be reasonably determined by the issuer.

The projected payment schedule for the convertible security 10 generally will include each noncontingent payment and a projected amount for each contingent payment. In some implementations, the amount of the projected payment may be the forward price and/or expected value of the contingent payments as of the issue date. Adjustments may be made to ensure that the projected payment schedule and the issue price of the instrument produce the comparable yield.

Application of the noncontingent bond method also involves determining the amount of interest for an accrual period, such as a taxable year. In general, the amount of interest for an accrual period is the product of the comparable yield and the tax adjusted issue price of the convertible security at the beginning of the accrual period. The “tax adjusted issue price” as of the end of an annual period is the tax adjusted issue price as of the beginning of the period (or the issue price if the period is the first period), plus the tax adjusted issue price as of the beginning of the period multiplied by the comparable yield, minus any non-contingent and projected contingent cash payments to be made during the period. Typically, the holder treats the interest as taxable income, and the issuer deducts the interest from its taxable income.

Application of the noncontingent bond method also may involve adjusting the amount of income or deductions. In some situations, the actual contingent payments may differ from the projected contingent payments. Accordingly, appropriate adjustments must be made by the issuer and the holder to reflect the difference. When the actual amount of the contingent payments is greater than the projected amount, a positive adjustment is made. A net positive adjustment generally is treated as interest and is included in taxable income by the holder of the instrument. The net positive adjustment is deductible by the issuer in the taxable year in which the adjustment occurs.

When the actual amount is less than the projected amount, however, a negative adjustment is made. A net negative adjustment generally reduces interest accruals on the debt instrument for the taxable year. However, there may be certain limitations if the net negative adjustment exceeds the interest for the taxable year.

Typically, the issue of recapture arises when the convertible securities cease to be outstanding due to conversion, an issuer's call, a holder's put, or maturity. The term “recapture” generally refers to the event when the issuer pays taxes on excess tax deductions because the value of securities and/or cash delivered to the holders is less than the tax adjusted issue price when the convertible ceases to be outstanding. It may often be the case that the convertible will be put, called or converted prior to maturity.

When the convertible security is put, called, converted or retired, the tax adjusted issue price is compared to the value of the securities and/or cash delivered to holders. If and when the convertible security 10 is converted, called, put or otherwise retired, the value of securities and/or cash delivered to the holders is less than the tax adjusted issue price, the issuer may pay tax on the difference between the tax adjusted issue price and the value of the securities and/or cash delivered. For example, if the stock underlying a zero-yield bond goes very low at year five, a company runs the risk of being required to pay back par as well as to pay income tax at the company's corporate tax rate on any prior excess deductions.

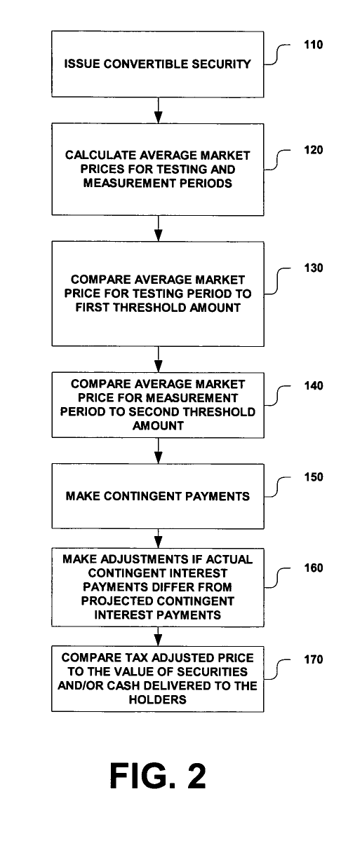

FIG. 2 illustrates a flowchart of one embodiment of a method 100 according to aspects of the present invention. In general, the method 100 may include issuing a convertible security (step 110), calculating a TAMP and MAMP of the convertible security (step 120), comparing the TAMP to a first threshold amount (step 130), comparing the MAMP to a second threshold amount (step 140), making contingent payments (step 150), making adjustments if the actual contingent interest payments differ from projected contingent interest payments (step 160), and calculating whether or not the issuer has taken excess tax deductions based on a comparison of the tax adjusted issue price and the value of securities and/or cash delivered to the holders (step 170).

At step 110, a convertible security is issued. The convertible security may be issued by a company and may be listed on a national securities exchange. One example of a convertible security is convertible debt such as a convertible bond (e.g., zero-coupon bond, discount bond, cash-pay bond). In general, the convertible security may qualify for treatment as a CPDI under the tax code if it includes a contingent interest feature.

In an example of one implementation, the convertible security is a five-year convertible bond having a 5% coupon. The convertible bond may specify conversion terms (e.g., price, premium rate) for exchanging the bond for stock and contingent payment terms (e.g., triggering conditions, amount) for making contingent payments in certain situations. In general, the payment contingency is neither remote nor incidental as required by the tax code.

At step 120, TAMP and MAMP of the convertible security are calculated. In one implementation, the TAMP of the convertible security is calculated over a testing period and the MAMP of the convertible security is calculated during a measurement period. For example, the contingent component 18 may provide that a contingent payment (e.g., contingent interest) will be paid to the holder if the TAMP is above the first threshold amount. The amount of the contingent interest payment will be based on the MAMP of the convertible security.

At step 130, the TAMP is compared to a first threshold amount. In one embodiment, the contingent component 18 may provide that a contingent payment (e.g., contingent interest) will be paid to the holder if the TAMP over a testing period (e.g., 5-day averaging period before year 5) is greater than a first threshold amount (e.g., $1400). The first threshold amount may be set so that there is more than a remote probability (e.g., 10% or greater) that the TAMP will be above this first threshold amount.

At step 140, the MAMP is compared to a second threshold amount. In one embodiment, the contingent component 18 may provide that contingent payments are made at different levels depending on whether the MAMP during the measurement period is greater than a second threshold amount.

At step 150, contingent payments are made. In one embodiment, the contingent component 18 may provide that if the TAMP of the convertible security during the testing period is greater than the first threshold amount and MAMP is less than the second threshold amount, then contingent interest is paid as a certain percentage of the MAMP of the convertible security.

In one implementation, the percentage Y is calculated so that the contingent interest payable is not insignificant. In one implementation, the second threshold amount may be calculated so that the theoretical probability of MAMP being above this second threshold amount is at least 10%, and Y may be calculated so that the contingent interest amount defined as Y multiplied by the second threshold amount is not insignificant. To measure whether this amount is insignificant or not, the amount may be measured against an amount that changes the internal rate of return (IRR) of the PPS cash flows by at least 5% of the IRR.

The contingent component 18 also may provide that if the TAMP (e.g. $1400) is greater than the first threshold amount and MAMP is greater than the second threshold amount (e.g. $1800), then contingent interest is payable as a certain percentage of the second threshold plus an additional percentage (e.g., 0.25%) of the difference between the MAMP and the second threshold amount (e.g., MAMP-$1800). This additional percentage payment when MAMP is above the second threshold amount may provide for an infinite number of possible payments since there is no limit for how high the additional payment could be. The infinite number of possible payments may be desirable because a finite number of payments may prevent application of the CPDI rules if one payment schedule is significantly more likely than not to occur.

At step 160, if actual contingent payments differ from the projected contingent payments, appropriate adjustments must be made to reflect the difference. These adjustments must be made when a projected contingent payment differs from an actual contingent payment at any time. When the actual amount of the contingent payments is greater than the projected amount, a positive adjustment is made. A net positive adjustment generally is treated as interest and is included in income by the holder of the instrument. The net positive adjustment is deductible by the issuer in the taxable year in which the adjustment occurs.

When the actual amount is less than the projected amount, however, a negative adjustment is made. A net negative adjustment generally reduces interest accruals on the debt instrument for the taxable year. However, there may be certain limitations if the net negative adjustment exceeds the interest for the taxable year.

At step 170, when the convertible security ceases to be outstanding, the tax adjusted issue price is compared to the value of the securities and/or cash delivered to the holders. In general, the convertible security will cease to be outstanding upon maturity, conversion, call, put or retirement.

If the value of securities and/or cash delivered to the holders is less than the tax adjusted issue price, the issuer may pay tax on the difference between the tax adjusted issue price and the value of the securities and/or cash delivered to the holders.

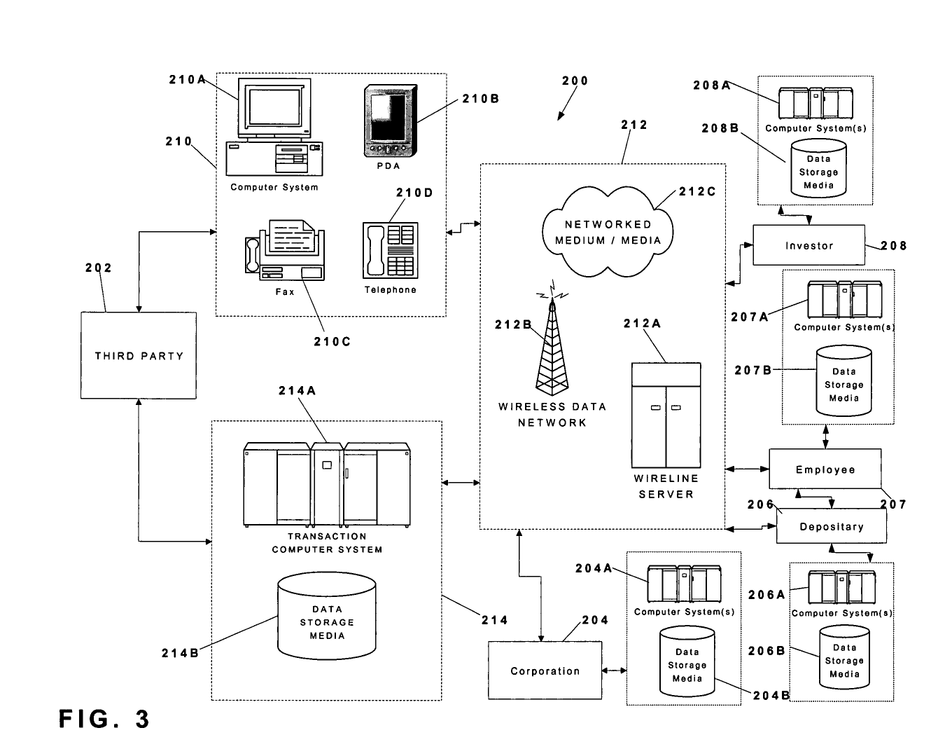

FIG. 3 is a diagram illustrating one embodiment of a system 200 in which aspects of the present invention may be used. As shown, a third party 202 such as, for example, an underwriter, an investment bank, or an entity can communicate and/or exchange data with one or more of a corporation 204, a depository 206 (e.g. The Depository Trust Company), an employee 207 and/or an investor 208.

In one implementation, the depository 206 may assign a unique identification such as a Committee Uniform Securities Identification Procedures (CUSIP) number, for example, to each security approved for trading. The CUSIP number may be used to track buy and sell orders for the units.

In one aspect, the third party 202 can be operatively associated with one or more communications devices 210 such as, for example and without limitation, a computer system 210A, a personal digital assistant 210B, a fax machine 210C, and/or a telephone 210D (e.g. a wireline telephone, a wireless telephone, a pager, and the like), and/or other like communication devices.

The communication devices 210 may permit the third party 202, the corporation 204, the depositary 206, the employee 207 and/or the investor 208 to communicate between/among each other through one or more communication media 212, such as by use of electronic mail communication through one or more computer systems, for example. The communication media 212 can include, for example and without limitation, wireline communication means such as a wireline server 212A, a wireless data network 212B, and/or a connection through a networked medium or media 212C (e.g., the Internet). In addition, the third party 202 (as well as any one or more of the corporation 204, the depositary 206, the employee 207 and/or the investor 208) can be operatively associated with one or more data processing/storage devices 214.

As illustrated in FIG. 3, the third party 202 can be operatively associated with a transaction computer system 214A, for example, and/or one or more data storage media 214B that can receive, store, analyze and/or otherwise process data and other information in association with communications that occur between/among the third party 202, the corporation 204, the depositary 206, the employee 207 and/or the investor 208.

In another aspect, the corporation 204 can be operatively associated with one or more computer systems 204A and/or one or more data storage media 204B. In another aspect, the depositary 206 can be operatively associated with one or more computer systems 206A and/or one or more data storage media 206B. In another aspect, the employee 207 can be operatively associated with one or more computer systems 207A and/or one or more data storage media 207B.

In another aspect, the investor 208 can be operatively associated with one or more computer systems 208A and/or one or more data storage media 208B. It can be appreciated that one or more of the computer systems (e.g., 204A, 206A, 207A, 208A, 214A) and one or more of the data storage media (e.g., 204B, 206B, 207B, 208B, 214B) can be employed to communicate, store, analyze, and/or otherwise process data related to financial transactions occurring between and/or among the third party 202, the corporation 204, the depositary 206, the employee 207 and/or the investor 208.

In one implementation, one or more elements of the system 200 may function as an issuing agent (e.g. underwriter) for issuing a convertible security to a holder. In one embodiment, the system 200 may be configured to store and modify the securities. For example, data entries within the system may expire or convert at a certain time.

The benefits of the present methods, systems and computer-readable media are readily apparent to those skilled in the art. The term “computer-readable medium” as used herein may include, for example, magnetic and optical memory devices such as diskettes, compact discs of both read-only and writeable varieties, optical disk drives, and hard disk drives. A computer-readable medium may also include memory storage that can be physical, virtual, permanent, temporary, semi-permanent and/or semi-temporary. A computer-readable medium may further include one or more data signals transmitted on one or more carrier waves. The various portions and components of various embodiments of the present invention can be implemented in computer software code using, for example, Visual Basic, C, or C++ computer languages using, for example, object-oriented techniques.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

1. A convertible security comprising:
a maturity component providing a maturity term of five years or less;
a conversion component providing terms and conditions for converting the convertible security for another asset; and
a contingent component providing one or more contingent payments triggered upon the occurrence of one or more specified conditions;
wherein the contingent component is structured to ensure that the convertible security qualifies for treatment as a contingent payment debt instrument under the tax code; and
wherein the comparable yield of the convertible security is greater than applicable Federal rate (AFR) plus five percentage points.

2. The convertible security of claim 1, wherein the contingent component provides a contingent payment if an average market price of the convertible security during a testing period is greater than a first threshold amount.

3. The convertible security of claim 2, wherein the first threshold amount is set such that there is a ten percent or greater probability that the average market price of the convertible security during the testing period will be above the first threshold amount.

4. The convertible security of claim 2, wherein the contingent component provides that if the average market price of the convertible security during the testing period is greater than the first threshold amount and the average market price of the convertible security during a measurement period is less than a second threshold amount, then contingent interest is paid as a certain percentage of the average market price of the convertible security during the measurement period.

5. The convertible security of claim 4, wherein the certain percentage is calculated such that the contingent interest is greater than a predetermined limit.

6. The convertible security of claim 2, wherein the contingent component provides that if the average market price of the convertible security during the testing period is greater than the first threshold amount and the average market price of the convertible security during the measurement period is greater than the second threshold amount, then a contingent payment is made equal to the certain percentage of the second threshold plus an additional percentage of the difference between the average market price of the convertible security during the measurement period and the second threshold amount.

7. The convertible component of claim 1, wherein the contingent component provides a testing period for evaluating whether a contingency is triggered.

8. The convertible component of claim 1, wherein the contingent component provides a measurement period for calculating the amount of contingent interest.

9. The convertible security of claim 8, wherein a contingent payment amount comprises a percentage of an average bond price of the convertible security during the measurement period.

10. The convertible security of claim 1, wherein a contingent payment amount is based on fixed values.

11. The convertible security of claim 1, wherein the final tax adjusted issue price is compared to a value of securities and/or cash delivered to convertible holders.

12. The convertible security of claim 11, wherein projected contingent payments are calculated based on one or more of forward prices and/or expected values of the contingent payments.

13. The convertible security of claim 1, further comprising a call component providing a call protection period.

14. The convertible security of claim 1, wherein the term is five years.

15. The convertible security of claim 1, further comprising a coupon component.

16. A financial method comprising the step of:
issuing a convertible security to a holder, the convertible security including a maturity component providing a maturity term of five years or less, conversion component providing terms and conditions for converting the convertible security for another asset, and a contingent component providing one or more contingent payments triggered upon the occurrence of one or more specified conditions,
wherein the contingent component is structured to ensure that the convertible security qualifies for treatment as a contingent payment debt instrument under the tax code; and
wherein the comparable yield of the convertible security is greater than applicable Federal rate (AFR) plus five percentage points.

17. The method of claim 16, further comprising calculating an average market price of the convertible security during a testing period.

18. The method of claim 16, further comprising calculating an average market price of the convertible security for a measurement period.

19. The method of claim 18, further comprising comparing the average market price of the convertible security during the testing period to a first threshold amount.

20. The method of claim 19, further comprising making a contingent payment if the average market price of the convertible security during the testing period is greater than the first threshold amount.

21. The method of claim 19, wherein the first threshold amount is set so that there is more than a ten percent probability that the average market price of the convertible security during the testing period will be above the first threshold amount.

22. The method of claim 19, further comprising comparing the average market price of the convertible security during a measurement period to a second threshold amount.

23. The method of claim 22, further comprising making a contingent payment equal to a certain percentage of the average market price of the convertible security during the measurement period if the average market price of the convertible security over the testing period is greater than the first threshold amount and the average market price of the convertible security during the measurement period is less than a second threshold amount.

24. The method of claim 22, further comprising making a contingent payment equal to the certain percentage of the second threshold amount, plus an additional percentage of the difference between the average market price of the convertible security during a measurement period and the second threshold amount, if the average market price of the convertible security during the testing period is greater than the first threshold amount and the average market price of the convertible security over the measurement period is greater than the second threshold amount.

25. The method of claim 15, further comprising comparison of the final tax adjusted issue price to a value of securities and/or cash delivered to convertible holders.

26. A computer system comprising:
an issuing agent for issuing a convertible security to a holder, the convertible security including a maturity component providing a maturity term of five years or less, a conversion component providing terms and conditions for converting the convertible security for another asset, and a contingent component providing contingent payments triggered upon the occurrence of one or more specified conditions, wherein the contingent component is structured to ensure that the convertible security qualifies for treatment as a contingent payment debt instrument under the tax code, and wherein the comparable yield of the convertible security is greater than applicable Federal rate (AFR) plus five percentage points.
